(19) United States
(12) Patent Application Publication
(10) Pub. No.: US 2023/0294542 A1
(43) Pub. Date: Sep. 21, 2023

(54) SCHEDULING METHOD FOR RESERVATION BASED CHARGING OF BATTERY OF URBAN AIR MOBILITY AND CONTROLLING SYSTEM FOR CHARGING BY THE SAME

(71) Applicants: Hyundai Motor Company, Seoul (KR); Kia Corporation, Seoul (KR)

(72) Inventors: Hui Un Son, Suwon (KR); Sung Il Jung, Busan (KR)

(21) Appl. No.: 17/900,116

(22) Filed: Aug. 31, 2022

(30) Foreign Application Priority Data
Mar. 18, 2022 (KR) 10-2022-0034033

(51) Int. Cl. B60L 53/63; B60L 53/64; B60L 53/62; H02J 7/00

(52) U.S. Cl. CPC B60L 53/63; B60L 53/64; B60L 53/62; H02J 7/0048; H02J 7/0071; B60L 53/50

(57) ABSTRACT

The present disclosure relates to a scheduling method for reservation-based charging for an urban air mobility (UAM) and a controlling system for the same. A scheduling method, according to an embodiment of the present disclosure, may be for reservation-based charging from a grid for an urban air mobility comprising a battery, a grid charging device configure to charge the battery with electric power from the grid, and at least one renewal-energy generator, the method comprising: calculating a required amount of electricity charge according to a target SOC and a remaining SOC of the battery, and determining a schedule of charging by the grid charging device according to the required amount of electricity charge and an amount of electricity generated by the generator from a first set time point to a second set time point.

### PRIORITY

This application claims under 35 U.S.C. § 119(a) the benefit of Korean Patent Application No. 10-2022-0034033, filed on Mar. 18, 2022, which is hereby incorporated by reference as if fully set forth herein.

### BACKGROUND OF THE DISCLOSURE

### Field of the Disclosure

The present disclosure relates to a scheduling method for reservation-based charging for an urban air mobility (UAM) and a controlling system for the same.

### Discussion of the Related Art

With a prospect that the number of megacities having populations of 10 million or more will be 43 or more in 2030, it may be prospected that the transportation demand will not be accommodated only by the land transport, and thus there will be no option but opening air routes.

As an alternative, an urban air mobility may be one of personal aircrafts capable of vertically taking off and landing, rising as a next-generation mobility solution with transport efficiency in urban areas maximized due to its capability of using airspace for new routes.

Chances may be very high that the urban air mobility uses the EV (Electric Vehicle) system in order to reduce noise and air pollution. That may be to say that the urban air mobility may comprise a rechargeable battery, an OBC (On Board Charger) for charging the battery with the grid, and a driving motor powered by the electricity from the battery.

In charging the battery, since the grid fee varies according to the season and time zones, technology for reservation-based charging in low-price time zones may be being developed.

For example, the below Table 1 shows the grid fee time zones by season set forth by the KEPCO (Korea Electric Power Corporation), and Table 2 shows fees per kWh for the time zones for charging an electric vehicle.

TABLE 1

| | | Spring/Fall | Winter |
|---|---|---|---|
| | Summer | (Mar. 1~May 31, | (Nov. 1~End of Feb. |
| Time Zone | (Jun. 1~Aug. 31) | Sep. 1~Oct. 31) | Next Year) |
| Light load time zone | 23:00~09:00 | 23:00~09:00 | 23:00~09:00 |
| Middle load time | 09:00~10:00 | 09:00~10:00 | 09:00~10:00 |
| zone | 12:00~13:00 | 12:00~13:00 | 12:00~17:00 |
| | 17:00~23:00 | 17:00~23:00 | 20:00~22:00 |
| Max. load time zone | 10:00~12:00 | 10:00~12:00 | 10:00~12:00 |
| | 13:00~17:00 | 13:00~17:00 | 17:00~20:00 |
| | | | 22:00~23:00 |

TABLE 2

| Time Zone | Summer | Spring/Fall | Winter |
|---|---|---|---|
| Light load time zone | \52.6 | \53.7 | \75.7 |
| Middle load time | \140.3 | \65.5 | \123.2 |
| zone | | | |
| Max. load time zone | \227.5 | \70.4 | \185.8 |

Taking the above time zones as an example, in summer, the time zones 10:00˜12:00 and 13:00˜17:00 may be preferred to be avoid, and the time zone 23:00˜09:00 preferred for the charging, but if not enough with that, the time zones 09:00˜10:00, 12:00˜13:00, and 17:00˜23:00 additionally preferred.

Accordingly, in a reservation-based charging for the urban air mobility, such an economical charging strategy may be preferred, and in case where regeneration of energy may be possible, the charging strategy may be preferred to be set with the amount of the energy regeneration before the scheduled departure hour taken into consideration.

### SUMMARY OF THE DISCLOSURE

An object of an embodiment of the present disclosure may be to provide a method for scheduling economic reservation-based charging for an urban air mobility and a controlling system for the same.

In particular, in case where the mobility may be equipped with an electricity generating means, the embodiment may be aimed to such scheduling for reservation-based charging that an amount of its generated electricity may be taken into consideration.

The object or problem-to-solve of the present disclosure may not be limited to the above mentioned, and additional objects will be set forth in part in the description which follows and in part will become apparent to those having ordinary skill in the art upon examination of the following or may be learned from practice of the disclosure.

A scheduling method, according to an embodiment of the present disclosure, may be for reservation-based charging from a grid for an urban air mobility comprising a battery, a grid charging device configure to charge the battery with electric power from the grid, and at least one renewal-energy generator, the method comprising: calculating a required amount of electricity charge according to a target SOC and a remaining SOC of the battery, and determining a schedule of charging by the grid charging device according to the required amount of electricity charge and an amount of electricity generated by the generator from a first set time point to a second set time point.

In at least one embodiment, the determining of the schedule comprises: determining an initial schedule for charging by the grid charging device according to the required amount of electricity charge; and determining a final schedule by changing the initial schedule according to the amount of electricity generated by the generator.

In at least one embodiment, the initial schedule comprises, for a time period from a start time to an end time for the charging by the grid charging device, a first charging obtaining a first charging amount of electricity during a first time period, a second charging obtaining a second charging amount of electricity during a second time period, and a third charging obtaining a third charging amount of electricity during a third time period.

In at least one embodiment, a grid fee per unit power for the first time period may be lower than those for the second and third time periods.

In at least one embodiment, in case where the amount of generated electricity may be equal to or below the second charging amount of electricity, the final schedule may be determined by changing the end time such that the second time period may be reduced as much correspondingly as the amount of generated electricity.

In at least one embodiment, in case where the amount of generated electricity may be over the second charging amount of electricity and equal to or below a sum of the second and third charging amounts of electricity, the final schedule may be determined by changing the end time such that the second charging may be excluded and changing the start time such that the third time period may be reduced as much correspondingly as an amount of subtracting the second charging amount of electricity from the amount of generated electricity.

In at least one embodiment, in case where the amount of generated electricity may be over a sum of the second and third charging amounts of electricity and equal to or below the required amount of electricity charge, the final schedule may be determined by changing the start time such that the third charging may be excluded and changing the end time such that the first time period may be reduced as much correspondingly as an amount of subtracting a sum of the second and third charging amounts of electricity from the amount of generated electricity.

In at least one embodiment, in case where a preset time zone may be only allowed for the charging by the grid charging device, the determining of the schedule comprises setting a start time and an end time within the preset time zone according to a time period as much correspondingly as an amount of subtracting the amount of generated electricity from the required amount of electricity charge.

In at least one embodiment, the schedule may be determined such that the charging by the grid charging device may be terminated before a departure time which may be determined by a user's selection.

In at least one embodiment, the second set time point may be set to be the departure time, and the first set time point may be determined according to information on a time point when the generator may be available to generate electricity.

In at least one embodiment, the generator comprises at least one propeller and a regenerative motor connected to the propeller, and wherein the amount of generated electricity may be calculated by Equation 1, where n indicates a number of propellers, to the first set time point, td the second set time point, ρ air density, Aeff effective area of the at least one propeller, Veff effective wind velocity, η efficiency of electric generation.

$$E = {\sum }_{k = 1}^{n} η {\int }_{{t}_{n}}^{{t}_{d}} \frac{1}{2} ρ {A}_{eff} {{V}_{eff} ( t )}^{3} dt \qquad [ Equation 1 ]$$

In at least one embodiment, the effective wind velocity Veff may be determined according to a parked angle of the mobility and information on wind direction.

In at least one embodiment, the efficiency of electric generation η, may be adjusted according to a ratio of an actual amount of generated electricity to the amount of generated electricity.

In at least one embodiment, the adjustment of the efficiency of electric generation η, may be suspended when the ratio may be out of a range in-between upper and lower limits

On the other hand, a charging control system, according to an embodiment of the present disclosure, may be configured to control reservation-based charging from a grid for an urban air mobility comprising a battery, a grid charging device configure to charge the battery with electric power from the grid, and at least one renewal-energy generator, the charging control system comprising: an input/output device, a memory, and at least one microprocessor, wherein the at least one microprocessor executes a program for at least one method described above.

In at least one embodiment, the amount of generated electricity may be obtained by using weather information from the first set time point to the second set time point.

In at least one embodiment, in case where a sum of the amount of generated electricity and the amount of charging by the grid charging device may be over the required amount of electric charge, a superfluous amount from the generated electricity may be supplied to outside via the grid charging device.

According to an embodiment of the present disclosure, reservation-based charging for an urban air mobility may be implemented economically.

In particular, in case where the mobility may be equipped with an electricity generating means, such reservation-based charging that an amount of its generated electricity may be taken into consideration may be scheduled.

Additional advantages and features of the disclosure will be set forth in part in the description which follows and in part will become apparent to those having ordinary skill in the art upon examination of the following or may be learned from practice of the disclosure. The objects and other advantages of the disclosure may be realized and attained by the structure particularly pointed out in the written description and claims hereof as well as the appended drawings.

### BRIEF DESCRIPTION OF THE DRAWINGS

FIGS. 1 to 4 represent an example of an embodiment of the present disclosure, showing a scheduling for reservation-based charging according to an amount of generated electricity in case where others than the low-price time zone EC may be allowed for charging.

FIG. 5 represents an example of an embodiment of the present disclosure, showing a scheduling for reservation-based charging according to an amount of generated electricity in case where the low-price time zone EC may be only allowed for charging.

FIG. 6 represents an example of a charging control system according to an embodiment of the present disclosure.

FIG. 7 represents an example of providing electricity to outside through a charging control system according to an embodiment of the present disclosure.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, embodiments of the present disclosure will be described in detail with reference to the accompanying drawings, and the same or similar elements will be given the same reference numerals regardless of reference symbols, and redundant description thereof will be omitted. In the following description, the terms “module” and “unit” for referring to elements may be assigned and used interchangeably in consideration of convenience of explanation, and thus, the terms per se do not necessarily have different meanings or functions. Further, in describing the embodiments disclosed in the present specification, when it may be determined that a detailed description of related publicly known technology may obscure the gist of the embodiments disclosed in the present specification, the detailed description thereof will be omitted. The accompanying drawings may be used to help easily explain various technical features and it should be understood that the embodiments presented herein may not be limited by the accompanying drawings. As such, the present disclosure should be construed to extend to any alterations, equivalents and substitutes in addition to those which may be particularly set out in the accompanying drawings.

Although terms including ordinal numbers, such as “first”, “second”, etc., may be used herein to describe various elements, the elements may not be limited by these terms. These terms may be generally only used to distinguish one element from another.

When an element may be referred to as being “coupled” or “connected” to another element, the element may be directly coupled or connected to the other element. However, it should be understood that another element may be present therebetween. In contrast, when an element may be referred to as being “directly coupled” or “directly connected” to another element, it should be understood that there may be no other elements therebetween.

A singular expression includes the plural form unless the context clearly dictates otherwise.

In the present specification, it should be understood that a term such as “include” or “have” may be intended to designate that the features, numbers, steps, operations, elements, parts, or combinations thereof described in the specification may be present, and does not preclude the possibility of addition or presence of one or more other features, numbers, steps, operations, elements, parts, or combinations thereof.

If not otherwise defined, all the terms in this Specification including technical or scientific ones means the same as what may be generally understood by a person having ordinary skill in the art. Such terms defined in generally used dictionaries should be interpreted to have the same meanings as what they mean by the context, and not to be ideal or excessively surficial meanings as far as not defined explicitly in this Specification.

In addition, the term “unit” or “control unit” included in the names of a hybrid control unit (HCU), a motor control unit (MCU), etc. may be merely a widely used term for naming a controller that controls a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

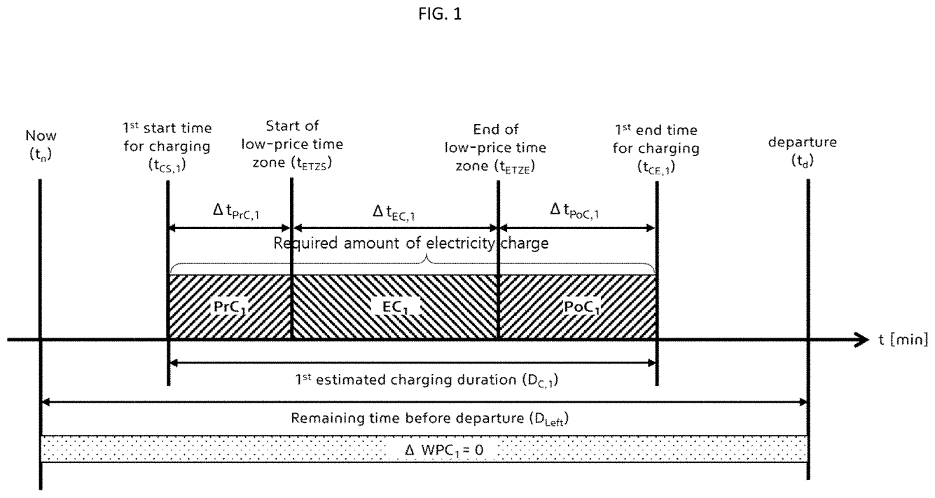

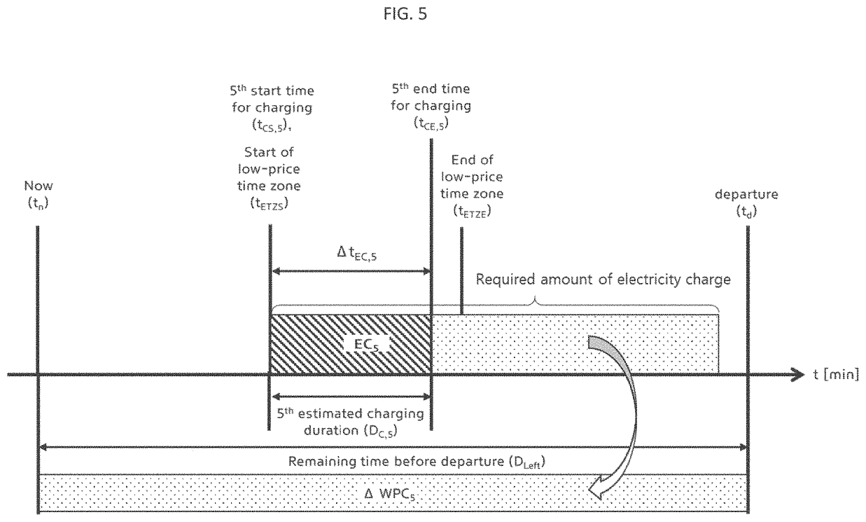

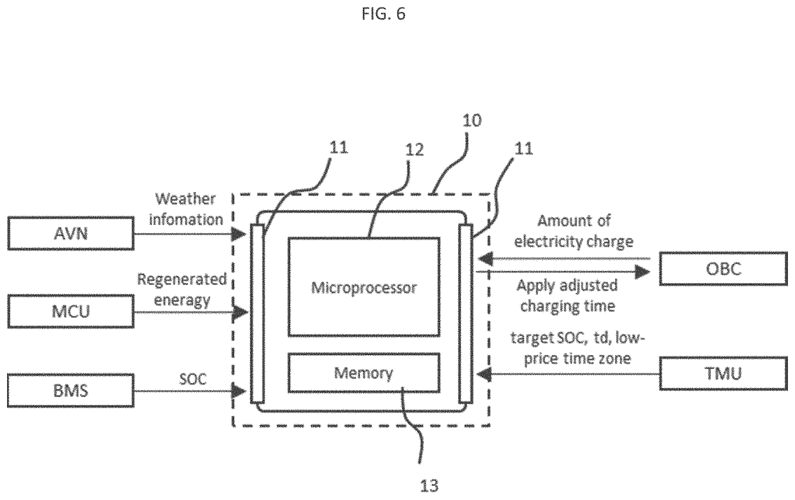

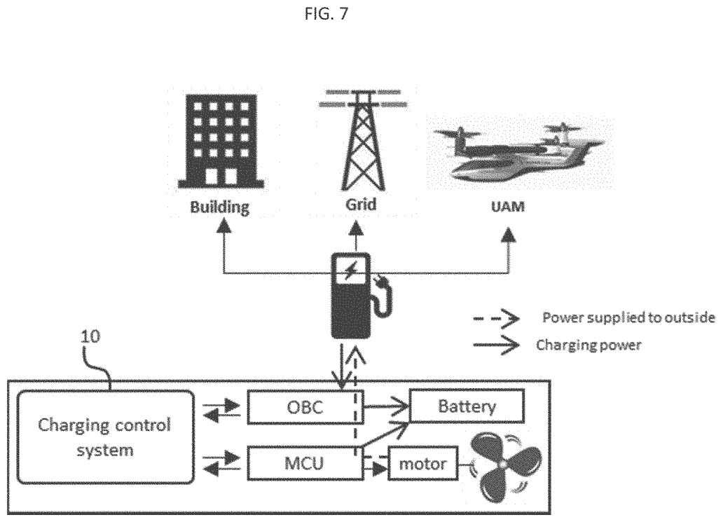

At first briefly describing attached FIGS., FIGS. 1 to 4 represent an example of an embodiment of the present disclosure, showing a scheduling for reservation-based charging according to an amount of generated electricity in case where others than the low-price time zone EC may be allowed for charging. FIG. 5 represents an example of an embodiment of the present disclosure, showing a scheduling for reservation-based charging according to an amount of generated electricity in case where the low-price time zone EC may be only allowed for charging. FIG. 6 represents an example of a charging control system according to an embodiment of the present disclosure. FIG. 7 represents an example of providing electricity to outside through a charging control system according to an embodiment of the present disclosure.

The term “low-price time zone” may mean a time zone of a price lower than that of any other zone in a day as described in Table 1 and Table 2 as an example, but the present disclosure may not be limited thereto.

For example, in a system of an embodiment of the present disclosure, the low-price time zone may be determined to be a time zone which may be set by a user's input through an AVN (Audio Video Navigation) system or a user's remote terminal like a smartphone with a telematics service program installed therein, or a time zone which may be automatically set according to a predetermined way based on grid fee information received from an outside server.

For the sake of convenience, in the embodiments in this Specification, the “low-price time zone” may be treated as meaning a time zone of a price lower than that of any other zone.

And also, in this Specification, an amount of generated electricity means an amount of electricity generated by a renewal-energy generator, and it may be premised that the urban air mobility of the embodiments may be equipped with such a renewal-energy generator.

The renewal energy source, here, may be wind.

For example, the urban air mobility may comprise at least one propeller and a regenerative motor which may rotate the propeller forward and generate electricity by the propeller rotating backward, such that the propeller and the regenerative motor may be used as a generator.

When the urban air mobility may be in a stand-by mode not in use, various system checks may be performed manually or automatically, and reservation-based charging may be performed for the next flight according to the SOC of the battery.

For the reservation-based charging, scheduling may be made first based on a required amount of electric charge for the next flight, an amount of electricity to be generated, whether or not for a time zone other than a low-price time zone to be allowed for charging, a departure hour, etc.

The required amount of electric charge may be calculated by subtracting a current SOC from a target SOC. And the target SOC may be determined, for example, by calculating an amount of electricity required to be consumed until the destination of the next flight, and the current SOC may be obtained from the BMS (Battery Management System). The target SOC, of course, may be determined to be the full SOC of the battery.

The amount of electricity to be generated, for example, may be calculated by Equation 2 below, as an amount of electricity to be generated by the propeller and the regenerative motor of the urban air mobility.

$$E = {\sum }_{k = 1}^{n} η {\int }_{{t}_{n}}^{{t}_{d}} \frac{1}{2} ρ {A}_{eff} {{V}_{eff} ( t )}^{3} dt \qquad [ Equation 2 ]$$

In Equation 2, n indicates the number of propellers, tn a first set time point, td a second set time point, ρ air density, Aeff effective area of a propeller, Veff effective wind velocity, η, efficiency of electric generation.

When calculating the amount of electricity to be generated, the first set time point tn may be a time point from when the generator may produce electricity or a current time point when the scheduling may be being performed with a premise that the generator may be in the state. And the second set time point td may be the departure time.

The air density p may be adjusted in value according to whether it rains or a humidity

The effective wind velocity Veff may be defined to be V cos θ which may be the perpendicular part of a wind velocity vector V to the propeller, wherein θ indicates the angle between the wind velocity vector and the rotational axis of the propeller.

The wind velocity vector may be obtained from wind direction information, and since the angle of the rotational axis of the propeller varies according to the parked angle of the urban air mobility, it may be obtained by a calculation with the parked angle information taken into consideration.

The AVN may provide real-time weather information received from an outside server through its display for user's convenience, the weather information including direction-time and velocity-time data of wind and being used for the calculation of the amount of electricity to be generated.

The efficiency of electric generation n may be adjusted according to the ratio of the actual amount of generated electricity to the amount of electricity to be generated, but the adjustment may be suspended when the ratio may be out of the range in-between upper and lower limits.

Whether or not a time zone other than a low-price time zone may be allowed for charging may be determined by a selection of a user. For example, the user may input the selection through the AVN or a remote terminal with a telematics service program installed therein (hereinafter, simply referred to as “remote terminal”).

The departure time, also, for example, may be input by the user through the AVN or the remote terminal.

In case where a time zone other than the low-price time zone may be allowed for charging, the schedule varies according to the amount of electricity to be generated, which may be detailed with FIGS. 1 to 4.

At first, FIG. 1 is for the case of the calculated amount of electricity to be generated ΔWPC1 being zero.

In this case, as shown, in case where the required amount of electric charge may be over the amount of electricity EC1 charged by the grid during the low-price time zone tETZS˜tETZE, the charging during one or more time zones after and/or before the low-price time zone tETZS˜tETZE may be included.

Each charging during the time zones after and before the low-price time zone tETZS˜tETZE may be determined so that each charging cost or their sum becomes minimal according to the fees for each time zone.

Or the charging after and before the low-price time zone tETZS˜tETZE may be determined with the time length from the current time point tn to the start time tETZS of the low-price time zone and the time length from the end time tETZE of the low-price time zone to the departure time tCE,1 taken into consideration. In other words, in case where the latter time length ΔtPoC,1 may be enough and the former ΔtPrC,1 may be insufficient, the charging before the low-price time zone tETZS˜tETZE may be excluded, and in the opposite case, the charging after the low-price time zone tETZS˜tETZE may be excluded.

FIG. 1 represents for the case of the charging during both of the time zones being included. In other words, in the charging schedule of FIG. 1, the whole period of the low-price time zone may be set as the first time period ΔtEC,1 and the charging during the corresponding period (hereinafter referred to as “the first charging”) may be included with the charging during the second time period ΔtPoC,1 (hereinafter referred to as “the second charging”) which may be after the low-price time zone and the charging the third time period ΔtPrC,1 (hereinafter referred to as “the third charging”) which may be before the low-price time zone.

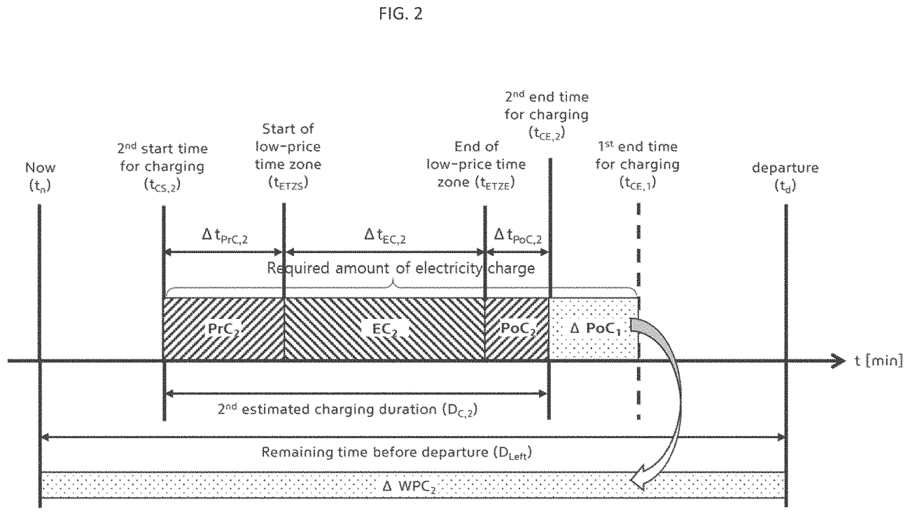

On the other hand, not only does FIG. 1 represent the charging schedule for the case of the actual amount of electricity to be generated being zero, but it may be also used as an initial charging schedule for the charging schedules of FIGS. 2 to 4 described below.

FIG. 2 represents the charging schedule for the case of the amount of electricity to be generated ΔWPC2 being equal to or below the initial second charging amount PoC1 of the charging schedule of FIG. 1.

As shown in FIG. 2, the final charging schedule may be determined by changing the end time of the grid charging from tCE,1 to tCE,2 such that the initial second time period ΔtPoC,1 may be reduced as much correspondingly as the amount of electricity to be generated ΔWPC2. In the final charging schedule, the length of the second time period becomes ΔtPoC,2 and the second charging amount becomes PoC2.

In case there may be an error in the calculation of the amount of electricity to be generated ΔWPC2, the target SOC may be satisfied by adjusting the end time tCE,2 of the grid charging and thus adjusting the second charging amount PoC2 as much correspondingly as the error amount.

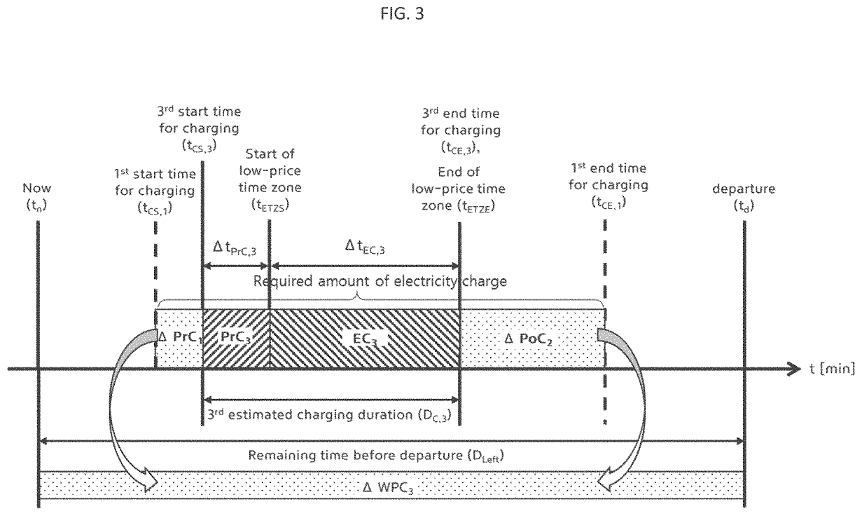

FIG. 3 represents the charging schedule for the case where the amount of electricity to be generated ΔWPC3 may be over the initial second charging amount PoC1 and below the sum, PoC1+PrC1, of the initial second and third charging amounts.

In this case, the final charging schedule may be determined by changing the end time of the grid charging from tCE,1 to tCE,3 so that the initial second charging may be excluded and changing the start time of the grid charging from tCS,1 to tCS,3 so that the initial third charging amount PrC1 may be reduced by the amount of subtracting the initial second charging amount PoC1 (or ΔPoC2) from the amount of electricity to be generated ΔWPC3.

In this case too, where there may be an error in the calculation of the amount of electricity to be generated ΔWPC3, the target SOC may be satisfied by adjusting the end time tCE,3 of the grid charging and thus adding the second charging amount as much correspondingly as the error amount.

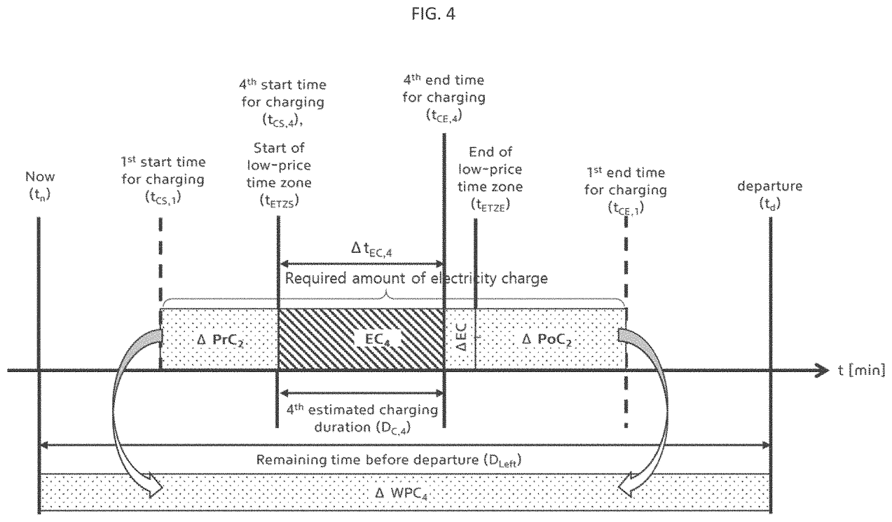

FIG. 4 represents the charging schedule for the case where the amount of electricity to be generated ΔWPC4 may be over the sum, PoC1+PrC1, of the initial second and third charging amounts and equal to or below the required amount of electric charge.

In this case, the final charging schedule may be determined by changing the start time of the grid charging from tCS,1 to tCS,4 so that the initial third charging may be excluded and changing the end time of the grid charging from tCE,1 to tCE,4 which may be before the end time tETZE of the low-price time zone so that the initial first charging amount EC1 may be reduced by the amount of subtracting the sum, PoC1+PrC1, of the initial second and third charging amounts from the amount of electricity to be generated ΔWPC4.

In case there may be an error in the calculation of the amount of electricity to be generated ΔWPC4, the target SOC may be satisfied by increasing the first charging amount EC4 and, if necessary, adding the second charging amount by an adjust of the end time tCE,4 of the grid charging.

The charging schedule for the case where the low-price time zone tETZS˜tETZE may be only allowed for charging may be detailed through FIG. 5.

In particular, FIG. 5 represents, in case where the required amount of electric charge may not be satisfied by only one of the initial first charging amount EC1 and the amount of electricity to be generated ΔWPC5, the scheduling for filling the amount of subtracting the amount of electricity to be generated ΔWPC5 from the required amount of electric charge with the first charging.

That may be to say, the charging schedule may be completed by setting the start time tCS,5 and the end time tCE,5 of the grid charging within the low-price time zone tETZS˜tETZE such that the grid charging time period becomes as long as the amount of subtracting the amount of electricity to be generated ΔWPC5 from the required amount of electric charge. The schedule of FIG. 5 is an example having the start time tETZS of the low-price time zone as the start time tCS,5 of the grid charging and a time point before the end time tETZE of the low-price time zone as the end time tCE,5 of the grid charging.

In this case too where there may be an error in the calculation of the amount of electricity to be generated ΔWPC5, the target SOC may be satisfied by adjusting the end time tCE,5 of the grid charging within the end time tETZE of the low-price time zone.

On the other hand, FIG. 6 represents a charging control system 10 according to an embodiment of the present disclosure, which may be detailed below.

The charging control system 10 of FIG. 6, first, may be included in such an urban air mobility as described above and implements the charging method of the described embodiment.

To this end, the charging control system 10 may comprise an input/output device 11, a memory 13, and at least one microprocessor 12, the microprocessor 12 executing a program for implementing the above described scheduling method for charging.

The memory 13 may store such a program and various necessary data for executing the program.

The input/output device 11 serves as an interface for receiving various necessary information for the scheduling from various relevant devices.

The charging control system 10, through the input/output device 11, as shown in FIG. 6, collects real-time weather information for the time period from the first set time point to the second set time point via the AVN for the calculation of the amount of electricity to be generated, an amount of electricity regenerated by the backward rotation of the propeller from a motor control unit (MCU), a current SOC of the battery from the battery management system (BMS), a target SOC, a departure time, information on the low-price time zone from a telematics unit (TMU). As described above, in case where the destination, the departure time, and information on the low-price time zone may be input by a user, they may be collected from the AVN.

The charging control system 10 executes the scheduling of the above described embodiments and controls the OBC for the charging to be performed according the schedule.

In case where the sum of the amount of electricity to be generated and the grid charging amount by the OBC may be over the required amount of electric charge, i.e., there may be superfluous amount of electricity from the generation of electricity until before the departure time, the superfluous amount may be supplied to outside via the OBC as shown in FIG. 7.

What is claimed is:

1. A scheduling method for reservation-based charging from a grid for an urban air mobility comprising a battery, a grid charging device configure to charge the battery with electric power from the grid, and at least one renewal-energy generator, the method comprising:
calculating a required amount of electricity charge according to a target SOC and a remaining SOC of the battery, and
determining a schedule of charging by the grid charging device according to the required amount of electricity charge and an amount of electricity generated by the at least one renewal-energy generator from a first set time point to a second set time point.

2. The method of claim 1, wherein the determining of the schedule comprises:
determining an initial schedule for charging by the grid charging device according to the required amount of electricity charge; and
determining a final schedule by changing the initial schedule according to the amount of electricity generated by the at least one renewal-energy generator.

3. The method of claim 2, wherein the initial schedule comprises, for a time period from a start time to an end time for the charging by the grid charging device, a first charging obtaining a first charging amount of electricity during a first time period, a second charging obtaining a second charging amount of electricity during a second time period, and a third charging obtaining a third charging amount of electricity during a third time period.

4. The method of claim 3, wherein a grid fee per unit power for the first time period is lower than those for the second and third time periods.

5. The method of claim 3, wherein, in case where the amount of electricity generated by the at least one renewal-energy generator is equal to or below the second charging amount of electricity, the final schedule is determined by changing the end time such that the second time period is reduced as much correspondingly as the amount of electricity generated by the at least one renewal-energy generator.

6. The method of claim 3, wherein, in case where the amount of electricity generated by the at least one renewal-energy generator is over the second charging amount of electricity and equal to or below a sum of the second and third charging amounts of electricity, the final schedule is determined by changing the end time such that the second charging is excluded and changing the start time such that the third time period is reduced as much correspondingly as an amount of subtracting the second charging amount of electricity from the amount of electricity generated by the at least one renewal-energy generator.

7. The method of claim 3, wherein, in case where the amount of electricity generated by the at least one renewal-energy generator is over a sum of the second and third charging amounts of electricity and equal to or below the required amount of electricity charge, the final schedule is determined by changing the start time such that the third charging is excluded and changing the end time such that the first time period is reduced as much correspondingly as an amount of subtracting a sum of the second and third charging amounts of electricity from the amount of electricity generated by the at least one renewal-energy generator.

8. The method of claim 1, wherein, in case where a preset time zone is only allowed for the charging by the grid charging device, the determining of the schedule comprises setting a start time and an end time within the preset time zone according to a time period as much correspondingly as an amount of subtracting the amount of electricity generated by the at least one renewal-energy generator from the required amount of electricity charge.

9. The method of claim 1, wherein the schedule is determined such that the charging by the grid charging device is terminated before a departure time which is determined by a user's selection.

10. The method of claim 9, wherein the second set time point is set to be the departure time, and the first set time point is determined according to information on a time point when the at least one renewal-energy generator is available to generate electricity.

11. The method of claim 1, wherein the at least one renewal-energy generator comprises at least one propeller and a regenerative motor connected to the at least one propeller, and wherein the amount of electricity generated by the at least one renewal-energy generator is calculated by an equation of
$$E = {\sum }_{k = 1}^{n} η {\int }_{{t}_{n}}^{{t}_{d}} \frac{1}{2} ρ {A}_{eff} {{V}_{eff} ( t )}^{3} dt$$
where n indicates a number of the at least one propeller, to the first set time point, td the second set time point, ρ air density, Aeff effective area of the at least one propeller, Veff effective wind velocity, η, efficiency of electric generation.

12. The method of claim 11, wherein the effective wind velocity Veff is determined according to a parked angle of the mobility and information on wind direction.

13. The method of claim 11, wherein the efficiency of electric generation η, is adjusted according to a ratio of an actual amount of generated electricity to the amount of electricity generated by the at least one renewal-energy generator.

14. The method of claim 13, wherein the adjustment of the efficiency of electric generation η, is suspended when the ratio is out of a range in-between upper and lower limits

15. A charging control system configured to control reservation-based charging from a grid for an urban air mobility comprising a battery, a grid charging device configure to charge the battery with electric power from the grid, and at least one renewal-energy generator, the charging control system comprising:
an input/output device, a memory, and at least one microprocessor,
wherein the at least one microprocessor executes a program for the method of claim 1.

16. The charging control system of claim 15, wherein the amount of electricity generated by the at least one renewal-energy generator is obtained by using weather information from the first set time point to the second set time point.

17. The method of claim 15, wherein, in case where a sum of the amount of electricity generated by the at least one renewal-energy generator and an amount of charging by the grid charging device is over the required amount of electric charge, a superfluous amount from the electricity generated by the at least one renewal-energy generator is supplied to outside via the grid charging device.
